(19) United States
(12) Patent Application Publication
(10) Pub. No.: US 2023/0325771 A1
(43) Pub. Date: Oct. 12, 2023

(54) SYSTEMS AND METHODS FOR DYNAMICALLY RE-ALLOCATING STORAGE CONTAINERS

(71) Applicant: Walmart Apollo, LLC, Bentonville, AR (US)

(72) Inventors: Andrew B. Millhouse, Gilbert, AZ (US); Kresimir Jambresic, Centerton, AR (US); Chad Smithpeters, Anchorage, AK (US)

(21) Appl. No.: 18/209,341

(22) Filed: Jun. 13, 2023

Related U.S. Application Data
(63) Continuation of application No. 16/240,202, filed on Jan. 4, 2019.
(60) Provisional application No. 62/613,915, filed on Jan. 5, 2018.

(51) Int. Cl. G06Q 10/0875; G05D 1/00; G06Q 10/0631

(52) U.S. Cl. CPC G06Q 10/0875; G05D 1/0088; G06Q 10/06313; G06Q 10/06315

(57) ABSTRACT

Systems and methods are described herein for dynamically re-allocating storage containers at a facility based on a number of factors including current and expected need for types of items at the facility and container cost considerations.

### CROSS-REFERENCE TO RELATED PATENT APPLICATIONS

This application is a continuation of U.S. application Ser. No. 16/240,202 filed Jan. 4, 2019, which claims the benefit of U.S. Provisional Application No. 62/613,915 filed on Jan. 5, 2018, all of which are incorporated herein by reference in their entirety.

### BACKGROUND

Facilities use storage containers for handling, storing, and transferring goods. The storage containers arrive at a facility through a variety of mechanisms including rail, sea, and tractor trailer transport. The containers themselves may be owned by the facility, rented by the facility, or owned by a third party resulting in varying costs for the containers being borne by the facility.

### BRIEF DESCRIPTION OF THE DRAWINGS

The accompanying drawings, which are incorporated in and constitute a part of this specification, illustrate one or more embodiments taught herein and, together with the description, help to explain the embodiments. The embodiments are illustrated by way of example and should not be construed to limit the present disclosure. In the drawings:

FIG. 1 illustrates a network diagram depicting a system for dynamically re-allocating storage containers at a facility, according to an exemplary embodiment;

FIG. 2 illustrates an exemplary method for dynamically re-allocating storage containers at a facility, according to an exemplary embodiment;

FIG. 3 is a block diagram of an exemplary computing device suitable for use in an embodiment.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE DISCLOSURE

Systems and methods are described herein for dynamically re-allocating storage containers at a facility based on a number of factors including current and expected need for types of items at the facility and container cost considerations. A facility may be a factory, warehouse, sub-assembly plant, freight transfer station, distribution center, or any other place where storage containers (hereafter referred to as a container or containers) are used. In one embodiment, an exemplary dynamic reallocation system includes multiple storage containers at a facility that each include one or more identifiers. Each of the identifiers is associated with storage container data relevant to the container. The container data includes an ownership status, a load volume, and a load type for a storage container. The exemplary dynamic reallocation system also includes a storage location storing the storage container data, such as, but not limited to, a database holding container data records indexed by the one or more identifiers.

The dynamic reallocation system also includes a server communicatively coupled to the storage location holding container data. The server is configured to execute a management module that when executed receives the one or more identifiers and retrieves the container data associated with the one or more identifiers from the storage location. The management module also identifies a first amount of a type of items in the facility and identifies a second amount of the type of items scheduled to be delivered to the facility over a specified time period. For example, the management module may identify how much of a particular type of product is present at a distribution center and how much of that type of product is scheduled to be delivered to the distribution center over the next two weeks or some other specified time period. The item data may be retrieved from the storage location or a different location or database that is communicatively coupled to the server. The management module further determines whether the combination of the first and second amounts exceeds a specified threshold. For example, criteria may be established for the facility indicating what amount of items should be on hand or expected over a two week or other time period. When the management module determines that the threshold of items will exceed the threshold, the management module identifies at least one candidate storage container among the storage containers at (or expected at) the facility in which to store an excess quantity of the type of items exceeding the specified threshold. The candidate storage container may be identified based on the storage container data (ownership status, load volume and load type) following the determination that the combination of the first and second amounts exceeds the specified threshold. The management module also generates and transmits a notification regarding the at least one candidate storage container, the notification including at least one of a transfer order and an inventory reallocation order for the at least one candidate storage container. The transfer order includes instructions regarding returning the at least one candidate container to a supplier or transferring the at least one candidate container to a different facility. The inventory reallocation order includes instructions regarding backloading inventory stored in the facility into the at least one candidate container. The processes by which transfer orders and inventory reallocation orders are generated are discussed further below.

In an embodiment, the dynamic reallocation system includes an autonomous or guided robotic device equipped with an imaging device or scanner configured to determine the one or more identifiers provided by the one or more containers located at the facility. The autonomous or guided robotic device is in communication with the server and configured to transmit the one or more identifiers to the server. It will be appreciated that the autonomous or guided robotic device, such as an aerial drone or ground vehicle, may also be equipped with other sensors to determine the one or more identifiers such as sensors enabling the receipt of beacons or RFID readers to receive a signal from an RFID tag on the container that is encoded with the identifier.

In one embodiment, an autonomous or guided robotic device may be configured to determine a load volume for the container by calculating a space volume for the container based on an image of the container interior. The calculated load volume may then be transmitted with the identifier to the server for use by the management module. In another embodiment, the autonomous or guided robotic device may receive the load volume data from a signal generated from the container (e.g. from a beacon or RFID tag programmed with the load volume data when the container was loaded).

In an embodiment, the dynamic reallocation system includes a mobile application executable on a mobile computing device operated by a user. The mobile computing device is equipped with an imaging device or scanner configured to determine the one or more identifiers provided by the one or more containers located at the facility. The mobile device is in communication with the server and configured to transmit the one or more identifiers to the server.

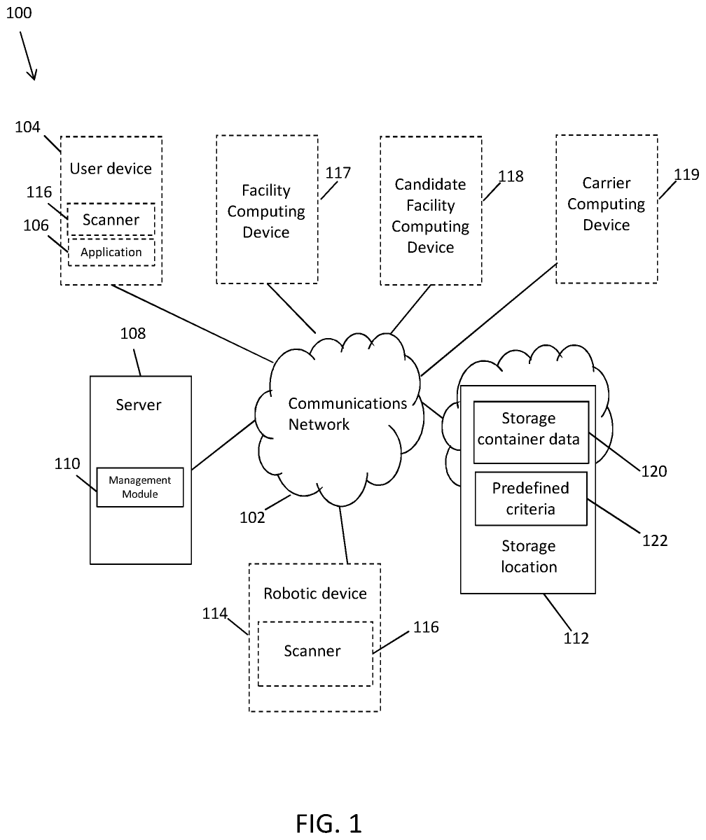

FIG. 1 illustrates a network diagram depicting a dynamic reallocation system 100 for dynamically re-allocating containers at a facility, according to an exemplary embodiment. System 100 includes a communication network 102, at least one server 108 executing a management module 110, and at least one storage location 112. Storage location may be a database located on a separate server, on server 108 or some other storage location on a computing device communicatively coupled to server 108. In some embodiments, system 100 further includes at least one autonomous or guided robotic device 114 equipped with an imaging device or scanner 116 to determine identifiers provided by containers. In additional embodiments, system 100 further includes at least one user device 104, such as a mobile computing device, including an application 106. The user device 104 is equipped with an imaging device or scanner 116 configured to determine identifiers provided by storage containers.

In still further embodiments, system 100 includes a facility computing device 117, a candidate facility computing device 118, and/or a carrier computing device 119. The facility computing device 117 is associated with a facility in possession of the containers. The candidate facility computing device 118 is associated with a candidate facility that may receive at least one container transferred from the facility. The carrier computing device 119 is associated with a carrier, and is configured to receive transfer orders from the management module that include instructions regarding the carrier retrieving at least one container, transferring at least one container to a candidate facility, and/or delivering additional containers to the facility.

In an exemplary embodiment, one or more portions of communication network 102 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other variety of network, or a combination of two or more such networks. The server 108, the storage location 112, and, in some embodiments, the user device 104, the autonomous or guided robotic device 114, the facility computing device 117, the candidate facility computing device 118, and/or the carrier computing device 119 are in communication with communication network 102.

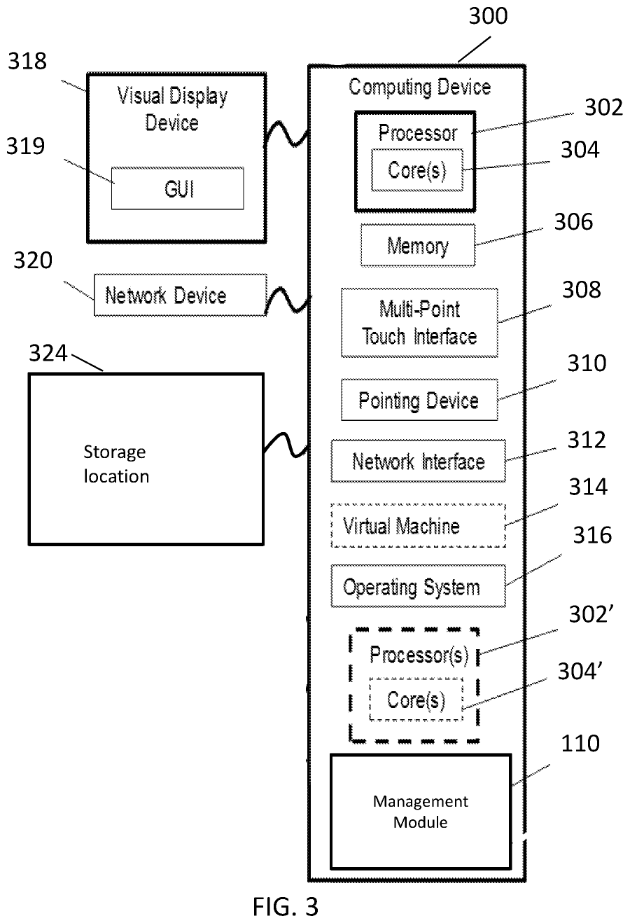

Application 106 may be associated with or installed on a number of different locations including, but not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, network PCs, mini-computers, and the like. Application 106 may connect to network 102 via a wired or wireless connection. Application 106 may include one or more applications such as, but not limited to, a web application and/or a mobile application to enable access to server 108, as described herein. Server 108 includes one or more computers or processors configured to communicate with application 106 via network 102. Server 108 can include one or more components of computing device 300 of FIG. 3.

Storage device(s) 112 may include one or more storage devices for storing files and/or data retrievable by server 108. In an exemplary embodiment, the storage device(s) 112 includes storage container data 120. Storage device(s) 112 and server 108 may be located at one or more geographically distributed locations from each other. Alternatively, storage device(s) 114 may be included within server 108.

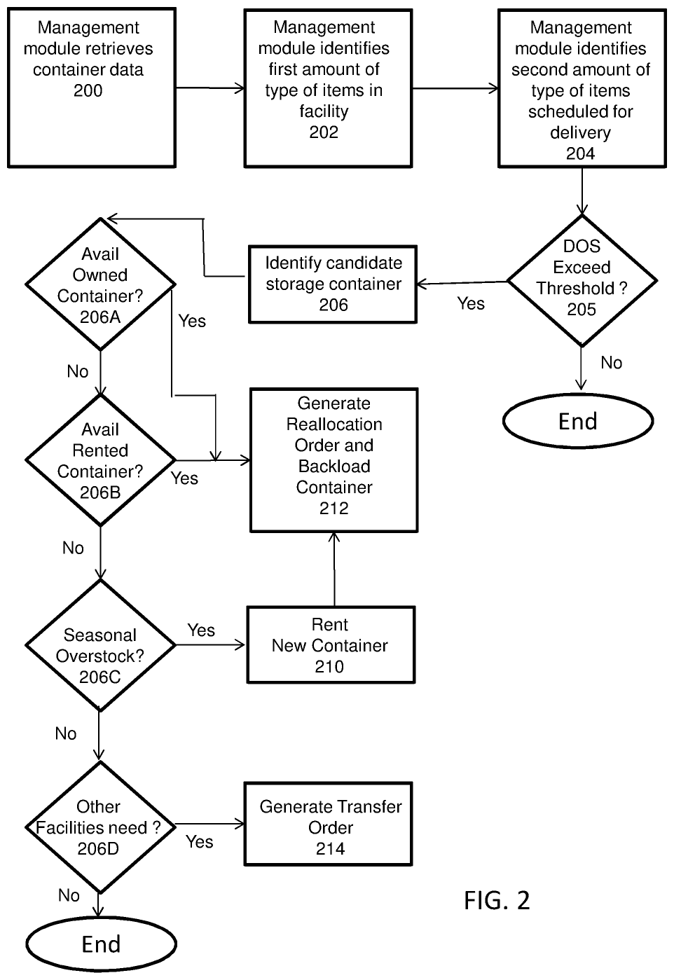

FIG. 2 is a flowchart illustrating an exemplary method for dynamically re-allocating storage containers at a facility, according to an exemplary embodiment. At step 200, the management module retrieves container data from a storage location such as a database. The container data is retrieved using identifiers for the respective containers. The identifier may be provided via a RFID tag, a QR code, a bar code, a transmitter, or other communications device or may be displayed physically (i.e., written on the container) or electronically via a display screen on the container. In one embodiment, the identifier may have been retrieved by an autonomous or guided robotic device that acquires the identifier from the container. In another embodiment, the identifiers may have been acquired for entry into the storage location using an application on a mobile device to scan or otherwise acquire the identifiers. Alternatively, the identifier may be manually entered into the storage location upon containers arrival at the facility. The container data includes an ownership status, a load volume, and a load type for a storage container.

At step 202, the management module identifies a first amount of a type of items present in the facility. For example, the management module may determine how much of a certain type of product is currently in the facility.

At step 204, the management module identifies how much of the same type of item is scheduled to be delivered to the facility over an upcoming specified time period. For example, the management module may determine how much of the product is due to be delivered to the facility in the next two weeks. It will be appreciated that the upcoming specified time period is a configurable parameter of the dynamic reallocation system.

At step 205, the management module 110 determines whether the facility has an excess supply of the type of item on hand (taking into consideration the deliveries scheduled in the upcoming specified time period) by determining how many days of supply (DOS) of the item type is present/will be present in the upcoming time period and comparing that DOS to a previously determined threshold. In one non-limiting example, the stock on hand is combined with/added to the scheduled delivery amounts (subtracting the expected sales over the specified time period using historical sales data) to determine a DOS for the item type. The threshold may be established based on historical sales data including time of year and other conditions. For example, the DOS for snow shovels may be a quantity of 200 in winter months but 20 in all other months. Among other reasons, the calculation to determine whether an item type exceeds a desired DOS is performed due to limited physical space for storing items in a facility. If the DOS does not exceed the threshold (step 205) the facility does not and will not have too much of the type of item in the specified time period and the sequence ends.

If the DOS does exceed the threshold (step 205), the management module identifies one or more candidate storage containers available for backloading or otherwise transferring the excess amounts at step 206. “Backloading” refers to storing items already at the facility into containers present at the facility. The identification of candidate storage containers occurs through a subsequence of steps 206A-206D. At step 206A, the management module first attempts to identify an available storage container that is owned by the facility that have already been paid for and can be kept indefinitely. In order for the owned container to be available, however, it must also have at least some available load volume in which to store the excess items and the items already in the container must be compatible with the items to be stored based upon pre-defined rules for item storage. For example, certain types of items perishable/non-perishable may not be allowed to be stored together and facilities may enforce restrictions regarding the storage of items from different departments in the same container. The load volume (how much of the container's storage space is occupied) is determined by the management module from the container data associated with the identifier for the container. In some embodiments, a certain percentage of the containers capacity must be unused for the container to be considered available. If an available owned container is identified (step 206A) then the management module generates a reallocation order to backload the container with excess quantities of the type of item at step 212. For example, the reallocation order may be transmitted to a facility employee or department with the responsibility for loading and unloading containers.

If the identified available owned container(s) are insufficient to store the excess amount of the DOS over the threshold, then at step 206B the management module attempts to identify one or more available rental containers. The determination requires identifying the remaining rental period in addition to determining the available load volume on the containers. In one embodiment, the remaining rental period must extend beyond the specified time period. In another embodiment, the remaining rental period must extend a designated number of days beyond the specified time period (to allow for unloading if necessary) in order for the rental container to be considered available. If an available rental container is identified (step 206B) then the management module generates a reallocation order to backload the container with excess quantities of the type of item at step 212.

At step 206C, if an insufficient number of owned or rental containers have been identified to store the excess items, the management module determines if the item is a seasonal item and the excess quantity therefore represents seasonal overstock. Seasonal items are items that are in high demand at a facility during certain time periods such as, but not limited to, snow removal items in winter. For these items, additional arrangements are made to attempt to keep the items on site at the facility. If the management module determines (such as by, but not limited to, consulting a lookup table of item types and time of year) that the item types represent a seasonal overstock, arrangements are made (subject to budget constraints) to deliver a new rental container to the facility at step 210. For example, in one embodiment, the management module may programmatically order another rental container to be delivered to the facility without user intervention. In another embodiment, the management module may generate a notification for an authorized individual or department that one or more additional rental containers are needed for seasonal overstock. For example, the notification may be included when the management module 110 transmits a daily report and/or recommendation(s) to a facility computing device 117 to enable the facility to dynamically manage the containers. Upon the new rental container's arrival at the facility, the management module generates a reallocation order to backload the container with excess quantities of the type of item at step 212.

If the excess quantity of items does not represent seasonal overstock (step 206C), then at step 206D the management module 110 determines whether one or more other facilities (candidate facilities) need the items. The determination may be made in a number of different ways. For example, the determination of whether the item type is needed at another facility may be made by, but is not limited to, querying other facilities computing devices directly regarding their need for the item or consulting a database holding data indicating how much of a particular item the other facilities have on hand. If one or more candidate facilities need the items, at step 214, the management module 110 generates a transfer order. The transfer order may arrange for a carrier to transport the items to the other facilities and may also include instructions to the facility computing device 117 notifying the facility to gather the items (for example, a store may build a pallet of the merchandise prior to transfer). If no other candidate facilities need the excess items, the sequence ends.

In one embodiment, in addition to renting additional containers for backloading seasonal overstock items, the management module may be configured to rent additional containers based on the identity of the department from which the types of items are sold or the association of the items with specific types of events. For example, weather events, such as hurricanes, floods, fires and blizzards as non-limiting examples, may dictate a desire by the facility management to keep additional amounts of certain types of items on site at the facility to assist in the aftermath of the events. Similarly, the management module may be configured to keep excess amounts of types of items associated with certain departments on hand if those items from that department are routinely in high demand.

In one embodiment, an autonomous or guided robotic device may be used to acquire identifiers from the containers at the facility and identify and/or determine a load volume for the containers. The load volume may be received by the autonomous or guided robotic device via a sensor such as by receiving beacon data or reading data from an RFID tag for the container. In another embodiment, the autonomous or guided robotic device may take an image of the interior of the container and calculate the available amount of space (i.e. calculate the current and/or remaining load volume for the container) from the image and data indicating the total unoccupied volume of the container. The load volume may be transmitted to the server executing the management module for use as container data in the operations described herein.

In one embodiment, if the management module determines that there are no available containers to store the excess items, the management module then determines whether a rental cost of a rental container is less than a predefined rental budget. In an example, if there is an eight week supply of seasonal overstock items, a rental container cost of $15 per day, and a rental budget of $1000, the management module determines that a cost of a rental container is $840 (8 weeks*7 days=56 days, 56 days*$15 per days=$840), which is less than the rental budget of $1000. If the rental cost is less than the rental budget, the management module transmits a notification to a carrier or rental company to deliver a rental container to the facility to backload the overstock items. The management module may update the database with contents, cubic feet, item grouping, etc. of the new container. Conversely, if the rental cost is more than the rental budget, the management module does not transmit a notification to a carrier or rental company to deliver a rental container to the facility unless the rental budget is increased.

FIG. 3 is a block diagram of an exemplary computing device 300 that can be used to perform one or more steps of the methods provided by exemplary embodiments. In an exemplary embodiment, computing device 300 is a computing system (i.e., server 108) and/or a user device (i.e., user device 104). Computing device 300 includes one or more non-transitory computer-readable media for storing one or more computer-executable instructions or software for implementing exemplary embodiments. The non-transitory computer-readable media can include, but are not limited to, one or more varieties of hardware memory, non-transitory tangible media (for example, one or more magnetic storage disks, one or more optical disks, one or more USB flashdrives), and the like. For example, a memory 306 included in computing device 300 can store computer-readable and computer-executable instructions or software for implementing exemplary embodiments. Computing device 300 also includes a processor 302 and an associated core 304, and optionally, one or more additional processor(s) 302′ and associated core(s) 304′ (for example, in the case of computer systems having multiple processors/cores), for executing computer-readable and computer-executable instructions or software stored in memory 306 and other programs for controlling system hardware. Processor 302 and processor(s) 302′ can each be a single core processor or multiple core (304 and 304′) processor. Computing device 300 may also include the management module 110.

Computing device 300 may include a browser application and a browser cache. As described above, browser application can enable a user to view notifications.

Virtualization can be employed in computing device 300 so that infrastructure and resources in the computing device can be shared dynamically. A virtual machine 314 can be provided to handle a process running on multiple processors so that the process appears to be using only one computing resource rather than multiple computing resources. Multiple virtual machines can also be used with one processor.

Memory 306 can include a computer system memory or random access memory, such as DRAM, SRAM, EDO RAM, and the like. Memory 306 can include other varieties of memory as well, or combinations thereof. In some embodiments, a user can interact with computing device 300 through a visual display device 318, such as a touch screen display or computer monitor, which can display one or more user interfaces 319 that can be provided in accordance with exemplary embodiments, for example, the exemplary user interfaces. Visual display device 318 may also display other aspects, elements and/or information or data associated with exemplary embodiments. Computing device 300 may include other I/O devices for receiving input from a user, for example, a keyboard or any suitable multi-point touch interface 308, a pointing device 310 (e.g., a pen, stylus, mouse, or trackpad). The keyboard 308 and pointing device 310 may be coupled to visual display device 318. Computing device 300 may include other suitable conventional I/O peripherals.

Computing device 300 can also include one or more storage devices 324, such as a hard-drive, CD-ROM, or other computer readable media, for storing data and computer-readable instructions and/or software, that implements embodiments of the dynamic reallocation system, as described herein, or portions thereof. Exemplary storage device 324 can also store one or more storage devices for storing any suitable information required to implement exemplary embodiments.

Computing device 300 can include a network interface 312 configured to interface via one or more network devices 322 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 312 can include a built-in network adapter, network interface card, PCMCIA network card, card bus network adapter, wireless network adapter, USB network adapter, modem or any other device suitable for interfacing computing device 300 to any variety of network capable of communication and performing the operations described herein. Moreover, computing device 300 can be any computer system, such as a workstation, desktop computer, server, laptop, handheld computer, tablet computer (e.g., the iPad® tablet computer), mobile computing or communication device (e.g., the iPhone© communication device), or other form of computing or telecommunications device that is capable of communication and that has sufficient processor power and memory capacity to perform the operations described herein.

Computing device 300 can run any operating system 316, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 316 can be run in native mode or emulated mode. In an exemplary embodiment, the operating system 316 can be run on one or more cloud machine instances.

The following description is presented to enable any person skilled in the art to create and use a computer system configuration and related method and systems, as taught herein. Various modifications to the exemplary embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step. Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

We claim:

1. A system for dynamically re-allocating storage containers at a facility, the system comprising:
a plurality of storage containers at a facility, each of the plurality of storage containers including one or more identifiers, at least one of the one or more identifiers is associated with storage container data comprising an ownership status of corresponding storage container, a load volume of the corresponding storage container, and a load type for the corresponding storage container, wherein the ownership status corresponds to one of facility owned and rented;
a storage location storing the storage container data;
an imaging device or a scanner configured to determine the one or more identifiers for each of the plurality of storage containers, the imaging device or the scanner in communication with a server and configured to transmit the one or more identifiers to the server;
the server communicatively coupled to the storage location and the imaging device or the scanner, wherein the server is configured to execute a management module that when executed:
retrieves the storage container data associated with the one or more identifiers from the storage location;
identifies at least one candidate storage container of the plurality of storage containers available for at least one of transfer from the facility and storing an excess quantity of items in the facility based on the storage container data; and
generates and transmits a notification regarding the at least one candidate storage container, the notification including at least one of a transfer order and an inventory reallocation order for the at least one candidate storage container.

2. The system of claim 1, wherein the imaging device or the scanner is coupled to an autonomous or guided robotic device.

3. The system of claim 2, wherein the autonomous or guided robotic device is an aerial drone or ground vehicle.

4. The system of claim 1, wherein the management module also identifies the at least one candidate storage container based on a seasonality of the type of item.

5. The system of claim 1, wherein the one or more identifiers are at least one of a RFID tag, a QR code, a bar code, or a beacon.

6. The system of claim 1, wherein the transfer order includes instructions regarding one of returning the at least one candidate storage container to a supplier and transferring the at least one candidate storage container to a different facility.

7. The system of claim 1, wherein the inventory reallocation order includes instructions regarding transferring an excess quantity of a type of items in the facility exceeding a specified threshold to the at least one candidate storage container.

8. The system of claim 1, further comprising an application executing on a mobile device equipped with the imaging device or the scanner, the application controlling the imaging device or the scanner to acquire the one or more identifiers for each of the plurality of storage containers, the mobile device in communication with the server and configured to transmit the one or more identifiers to the server.

9. A method for dynamically re-allocating storage containers at a facility, the method comprising:
determining, by an imaging device or a scanner in communication with a server, one or more identifiers for each of a plurality of storage containers at the facility, the imaging device or the scanner in communication with a server and configured to
transmitting, by the imaging device or the scanner, the one or more identifiers to the server;
retrieving, by the server from a storage location, storage container data associated with one or more identifiers provided for each of a plurality of storage containers at the facility, each identifier associated with storage container data for at least one of the plurality of storage containers that includes an ownership status, a load volume, and a load type for the storage container;
identifying, by the server, at least one candidate storage container of the plurality of storage containers in which to store an excess quantity of items in the facility based on the storage container data; and
generating and transmitting, by the server, a notification regarding the at least one candidate storage container, the notification including at least one of a transfer order and an inventory reallocation order for the at least one candidate storage container.

10. The method of claim 9, wherein the autonomous or guided robotic device is an aerial drone or ground vehicle.

11. The method of claim 10 wherein the autonomous or guided robotic device is an aerial drone or ground vehicle.

12. The method of claim 9, wherein the management module also identifies the at least one candidate storage container based on a seasonality of the type of item.

13. The method of claim 9, wherein the one or more identifiers are at least one of a RFID tag, a QR code, a bar code, or a beacon.

14. The method of claim 9, wherein the transfer order includes instructions regarding one of returning the at least one candidate storage container to a supplier and transferring the at least one candidate storage container to a different facility.

15. The method of claim 9, wherein the inventory reallocation order includes instructions regarding transferring an excess quantity of a type of items in the facility exceeding a specified threshold to the at least one candidate storage container.

16. The method of claim 9, further comprising executing an application on a mobile device equipped with the imaging device or the scanner, the application controlling the imaging device or the scanner to acquire the one or more identifiers for each of the plurality of storage containers, the mobile device in communication with the server and configured to transmit the one or more identifiers to the server.

17. A system for dynamically re-allocating storage containers at a facility, the system comprising:
a plurality of storage containers at a facility, each of the plurality of storage containers including one or more identifiers, at least one of the one or more identifiers is associated with storage container data comprising an ownership status of corresponding storage container, a load volume of the corresponding storage container, and a load type for the corresponding storage container, wherein the ownership status corresponds to one of facility owned and rented;
a storage location storing the storage container data;
an autonomous or guided robotic device equipped with an imaging device or a scanner configured to determine the one or more identifiers for each of the plurality of storage containers and to determine a load volume for each of the plurality of storage containers; and
a server communicatively coupled to the robotic vehicle and the storage location and configured to execute a management module that when executed:
retrieves the storage container data associated with the one or more identifiers from the storage location;
identifies at least one candidate storage container of the plurality of storage containers in which to store an excess quantity of a type of items in the facility exceeding a specified threshold based on the storage container data; and
generates and transmits a notification regarding the at least one candidate storage container, the notification including at least one of a transfer order and an inventory reallocation order for the at least one candidate storage container.

18. The system of claim 17 wherein the autonomous or guided robotic device is an aerial drone or ground vehicle.

19. The system of claim 17, wherein the management module also identifies the at least one candidate storage container based on a seasonality of the type of item.

20. The system of claim 17, wherein the one or more identifiers are at least one of a RFID tag, a QR code, a bar code, or a beacon.
